(19) United States
(12) Patent Application Publication
(10) Pub. No.: US 2016/0127234 A1
(43) Pub. Date: May 5, 2016

(54) Service Router

(71) Applicant: Basware Oyj, Espoo (FI)

(72) Inventors: Mika VANSKA, Espoo (FI); Mika LEHTO, Espoo (FI); Timo HOTTI, Espoo (FI)

(21) Appl. No.: 14/923,786

(22) Filed: Oct. 27, 2015

(30) Foreign Application Priority Data
Oct. 31, 2014 (FI) 20140302

(51) Int. Cl. H04L 12/741; H04L 29/12

(52) U.S. Cl. CPC H04L 45/74; H04L 61/25

(57) ABSTRACT

The invention concerns a computer executable method for routing a transaction in a transaction transmission network comprising at least one sender, at least one recipient, at least one application service and a service router. The method is characterized in that it comprises steps executable by a computer for receiving a transaction from the network at an address activated for the purpose of enabling at least one application and/or routing service for the transaction wherein the address comprises an identifier associable with the sender, executing, by the service router and while the transaction is being routed to the recipient, an address translation or verification function to enable transmission of the transaction to the recipient, associating the transaction with at least one application service for the purpose of managing availability of the received transaction and/or further data associable with the received transaction to the application service, and forwarding the transaction to the recipient in the network. An arrangement and a computer storage medium are also disclosed.

### BACKGROUND

This patent application concerns a method and arrangement for routing transactions, e.g. business transactions, e.g. invoices and/or purchase orders, in a data communication network comprising senders, receivers and value-add service providers, e.g. financing service providers.

Transaction transmission networks are typically closed networks where the sender, the receiver and the possible value-add service providers need to reside in the same network. The addresses (end points) of the participants are typically unique within each network.

There may be co-operation agreements between two transaction transmission networks who agree to transmit transactions between each other. Such arrangements allow transmission of transactions from the sender of the first network to the receiver of the second network.

Providers of transaction-related value-add services would like to be able to provide their services to the customers of a number of closed networks. This, however would require laborous adaptation of the service for the technical and software architecture each transmission network.

An object of the present invention may be to provide a routing method, arrangement and/or storage medium comprising computer executable program code for connecting together a plurality of transaction transmission networks, that may be operated by different operators, and facilitating a routing platform for the value-add service providers to provide services to the transactions of the customers of the connected networks. Another object of the present invention may be an efficient implementation mechanism for value-add services related to business transactions, e.g. invoices. Yet another object of the invention may be a profit sharing method in a transaction transmission network comprising value-add services.

### BRIEF DESCRIPTION OF THE INVENTION

An aspect of the invention is a computer executable method for routing a transaction in a transaction transmission network comprising at least one sender, at least one recipient, at least one application service and a service router. The method may be characterized in that it comprises steps executable by a computer for:
receiving a transaction from the network at an address activated for the purpose of enabling at least one application and/or routing service for the transaction wherein the address comprises an identifier associable with the sender,
executing, by the service router and while the transaction is being routed to the recipient, an address translation or verification function to enable transmission of the transaction to the recipient,
associating the transaction with at least one application service for the purpose of managing availability of the received transaction and/or further data associable with the received transaction to the application service, and
forwarding the transaction to the recipient in the network.

The application service may be e.g. a value-add service, e.g. a financing service, that may be subscribed by the sender or receiver of the transaction.

The network may also comprise at least one second router. The step of forwarding the transaction to the recipient may comprise forwarding the transaction to the second router adapted to route the transaction to recipient directly or via at least one other second router.

In an embodiment, the address verification function is adapted to check, if the service router is able to route the transaction to the recipient using the address provided by the sender. The address verification function may be adapted to accept the transaction for routing, if it deems possible to perform the routing to the recipient.

In an embodiment, the address translation function is adapted to alter the recipient address of the transaction while it is being processed at the service router. The translation function may perform translation between an address comprising a virtual endpoint address and a physical endpoint address.

In an embodiment, the recipient address of the received transaction comprises the sender's virtual endpoint address at the service router and the physical delivery address to the recipient is available in the transaction's data.

In an embodiment, the recipient address of the received transaction comprises the recipient's virtual endpoint address at the service router.

In an embodiment, the address translation function is a service accessible by a second router in the network and the service provides the translated address upon request by the second router.

In an embodiment, the network comprises a plurality of separately operated networks wherein at least one first network is adapted to route transactions to at least one second network. In an embodiment, the sender and the receiver reside in separate networks and the sender's network is unable to route the transaction directly to the receiver's network.

The method may further comprise the step of amending the transaction's data with at least one URL associable with at least one service applicable to the transaction and/or the recipient of the transaction.

The address translation step may comprise the step of resolving the end recipient's delivery address in the recipient's network from the content of the received transaction.

The method may also comprise the steps of receiving the delivery success status information about the forwarded transaction, and maintaining data of the storage of the service router using the address and delivery status information of the transaction.

The address information of the recipient of the transaction may be published in a public directory if the delivery of the transaction was successful.

The method may also comprise the step of debiting or crediting the financial account of at least one of the sender, receiver, the at least one router and application service provider based on the routing data of the transaction and after completion of a chargeable service related to the transaction.

The method may also comprise the step of altering the payment instruction data of the transaction, if the type of the transaction is an invoice. The altered payment instruction data may comprise bank account of the operator of the service router.

Another aspect of the present invention may be a method for routing a transaction, e.g. an invoice, associable with a later response transaction, e.g. a payment or a status change event. The method may be characterized in that it comprises steps for:
receiving the transaction from the sender, the transaction being associable with at least one application service to be involved in the processing of the transaction in addition to the end recipient,
modifying the content of the transaction or creating a new transaction with modified content to alter the execution and/or routing instructions of a later transaction, e.g. a response transaction, associable with the received transaction,
forwarding the transaction to the end recipient, e.g. the buyer of the invoice, according to the information of the received transaction,
making data of the transaction available to the application service, e.g. a value-add service, e.g. a financing service, according to the subscription information of a subscribed service associable with the transaction,
receiving the later associable transaction, and
forwarding the later associable transaction to at least one of the application service and the sender.

Another aspect of the present invention may be a method for managing revenues related to a transaction in a network comprising at least one data source and at least one computer-implemented value-add service. The method may be characterized in that it comprises e.g. a subset of or all of the steps of:
receiving a transaction from one of the at least one data source,
altering or amending the content or address data of the received transaction,
forwarding the altered or amended transaction to the end recipient,
making data of the transaction available to at least one value-add service,
observing a value-add event that indicates that the subscriber of the value-add service has been, is being or will be charged a fee,
debiting a first share of the charged fee from the provider of the value-add service,
crediting a second share of the fee to at least one data source providing, e.g. according to the routing data of at least one transaction, data required by the value-add service.

The altering or amending of the transaction's data may comprise creating at least one new version of the transaction.

Another aspect of the present invention is an arrangement comprising at least one server computer. The arrangement is adapted to comprise computer executable means for performing the steps of at least one of the methods disclosed herein. Therefore, an aspect of the invention may be e.g. an arrangement for routing a transaction in a transaction transmission network comprising at least one sender, at least one recipient, at least one application service and a service router. The arrangement may be characterized in that it comprises computer means for:
receiving a transaction from the network at an address activated for the purpose of enabling at least one application and/or routing service for the transaction wherein the address comprises an identifier associable with the sender,
executing, by the service router and while the transaction is being routed to the recipient, an address translation or verification function to enable transmission of the transaction to the recipient,
associating the transaction with at least one application service for the purpose of managing availability of the received transaction and/or further data associable with the received transaction to the application service, and
forwarding the transaction to the recipient in the network.

Yet another aspect of the present invention is a tangible computer readable memory medium comprising a computer program product. The product is adapted to comprise computer executable instructions for the purpose of performing at least one combination of steps of at least one of the methods disclosed herein. Therefore, an aspect of the invention may be e.g. a tangible computer storage medium comprising computer executable program code for routing a transaction in a transaction transmission network comprising at least one sender, at least one recipient, at least one application service and a service router. The storage medium may be characterized in that it comprises computer executable instructions for:
receiving a transaction from the network at an address activated for the purpose of enabling at least one application and/or routing service for the transaction wherein the address comprises an identifier associable with the sender,
executing, by the service router and while the transaction is being routed to the recipient, an address translation or verification function to enable transmission of the transaction to the recipient,
associating the transaction with at least one application service for the purpose of managing availability of the received transaction and/or further data associable with the received transaction to the application service, and
forwarding the transaction to the recipient in the network.

### DRAWINGS

Some preferred embodiments of the invention are described below with references to accompanied figures, where:

FIG. 1a illustrates an exemplary computer arrangement according to a preferred embodiment of the present invention,

FIG. 1b illustrates another exemplary computer and service arrangement according to a preferred embodiments of the present invention,

FIG. 1c illustrates yet another exemplary computer and service arrangement according to a preferred embodiment of the present invention,

FIG. 2a illustrates some exemplary data objects according to a preferred embodiment of the present invention,

FIG. 2b illustrates some exemplary invoice data objects according to a preferred embodiment of the present invention,

FIG. 3a depict, in the form of a flow chart, a method of routing a transaction according to an embodiment of the present invention,

FIG. 3b depicts, in the form of a flow chart, a method of adding a new recipient to the network according to an embodiment of the present invention,

FIG. 3c depicts, in the form of a flow chart, a method of provisioning a set of services according to an embodiment of the present invention,

FIG. 3d depicts, in the form of a flow chart, a method of routing a response transaction according to an embodiment of the present invention,

FIG. 4 depicts an exemplary method of constructing a URL usable in some preferred embodiments of the present invention,

FIG. 5 shows an example of a revenue sharing scheme implementable with the service router of a preferred embodiment of the present invention,

FIG. 6 shows an event diagram about implementing a financing service such as dynamic discounting according to an embodiment of the present invention, and

FIG. 7 depicts an exemplary diagram of a computer usable in the various embodiments of the present invention.

### DETAILED DESCRIPTION OF THE INVENTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities.

Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

Some embodiments of the present disclosure may include one or application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. An API may also implement functions having parameters, variables, or pointers. An API may receive parameters as disclosed or other combinations of parameters. In addition to the APIs disclosed, other APIs individually or in combination can perform similar functionality as the disclosed APIs.

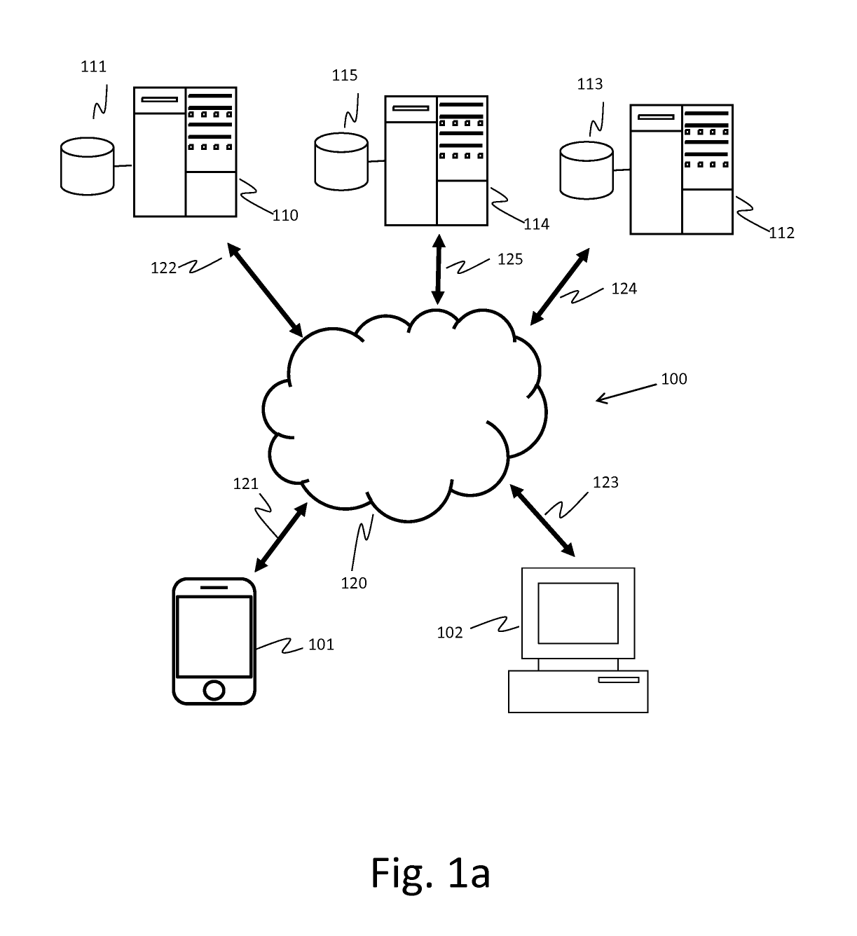

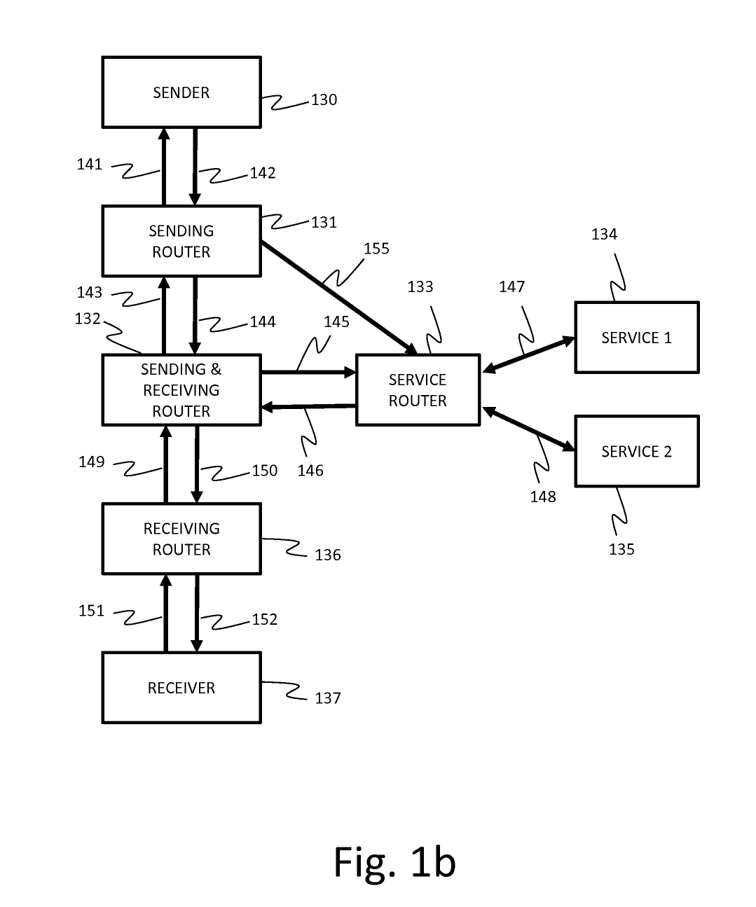

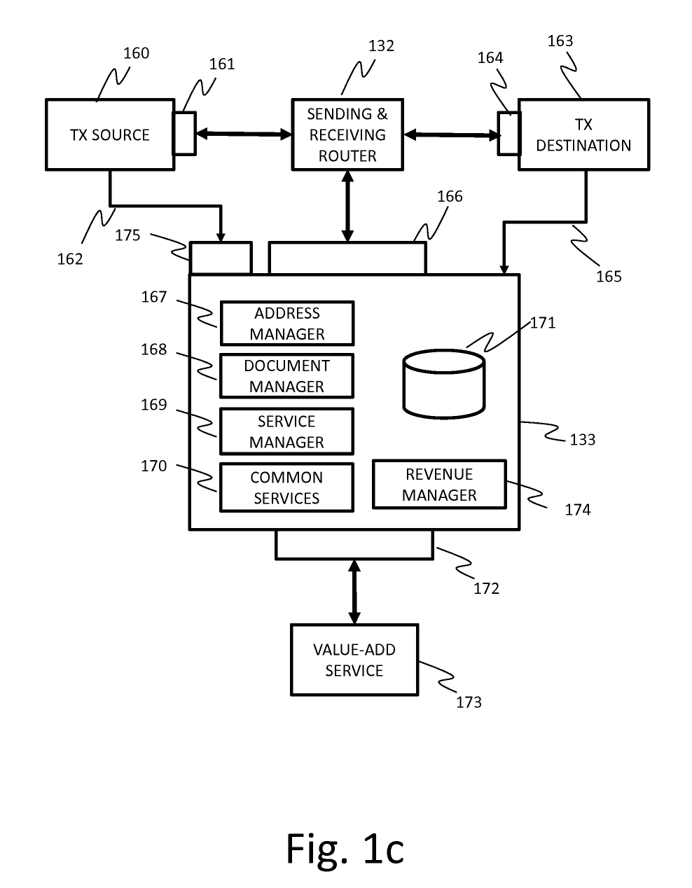

FIG. 1a depicts a computer and data communication arrangement 100 according to a preferred embodiment of the present invention. The arrangement comprises a data communication network 120, e.g. a TCP/IP network, e.g. the Internet. Connected to the network are a plurality of server computers 110, 112, 114 and terminal computers 101 and 102. In a preferred embodiment, the server computer 110 having a storage 111 and connected to the network using network connection 122 is adapted to act as a source of transactions that is capable of sending transactions to the transaction transmission network that utilizes the data communication services of a data communication network 120, and to receive response messages and other transactions related to the sent transactions. The server computer 112 having a storage 113 and connected to the network using communication connection 124 is adapted to act as a destination of transactions capable of receiving transactions from the transaction transmission network and sending response messages and/or transactions back to the network 120. In an embodiment, the system 112 comprises an electronic invoice processing system adapted to receive invoice, have them approved and eventually paid. The arrangement further comprises server computer 114 having a storage 115 and connected to the network using communication connection 125. The server computer 114 comprises software-based services adapted to provide the functionality of a service router according to a preferred embodiment of the present invention. In addition to the server computers 114, 112 and 110, the arrangement may comprise a plurality of terminal computers 101, 102 connected to the data communication network 120 using connections 121, 123. The terminal computers may access e.g. the services provided by the service router 114 using some suitable communication technique, e.g. HTML transmitted over HTTP.

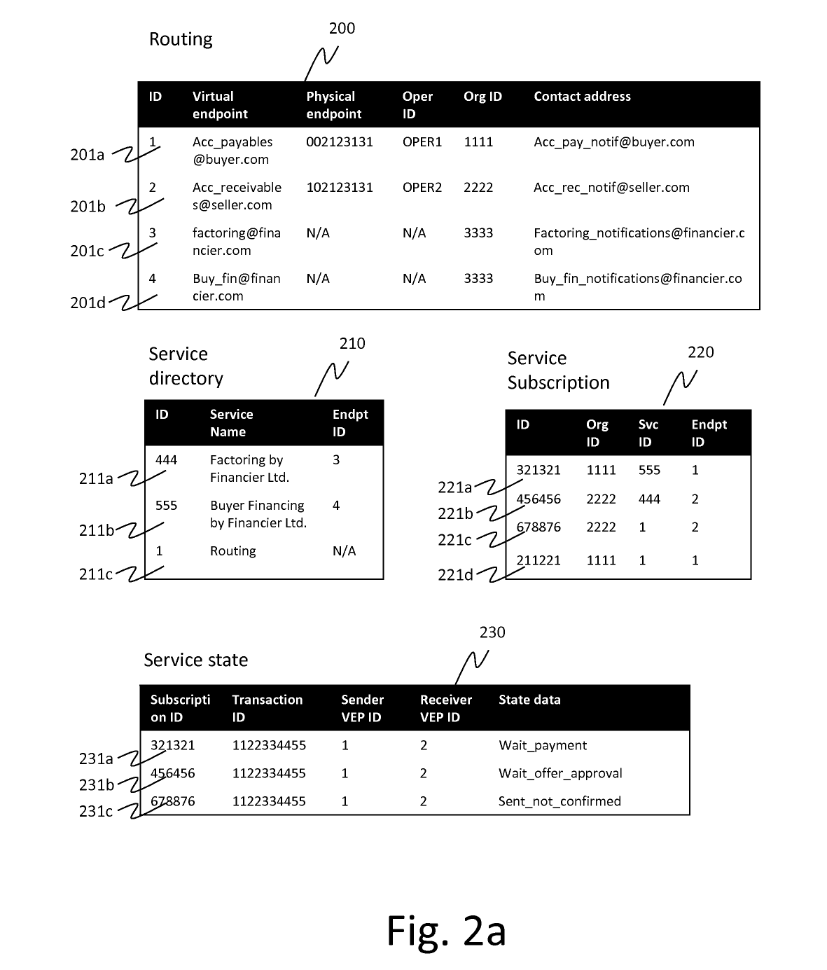

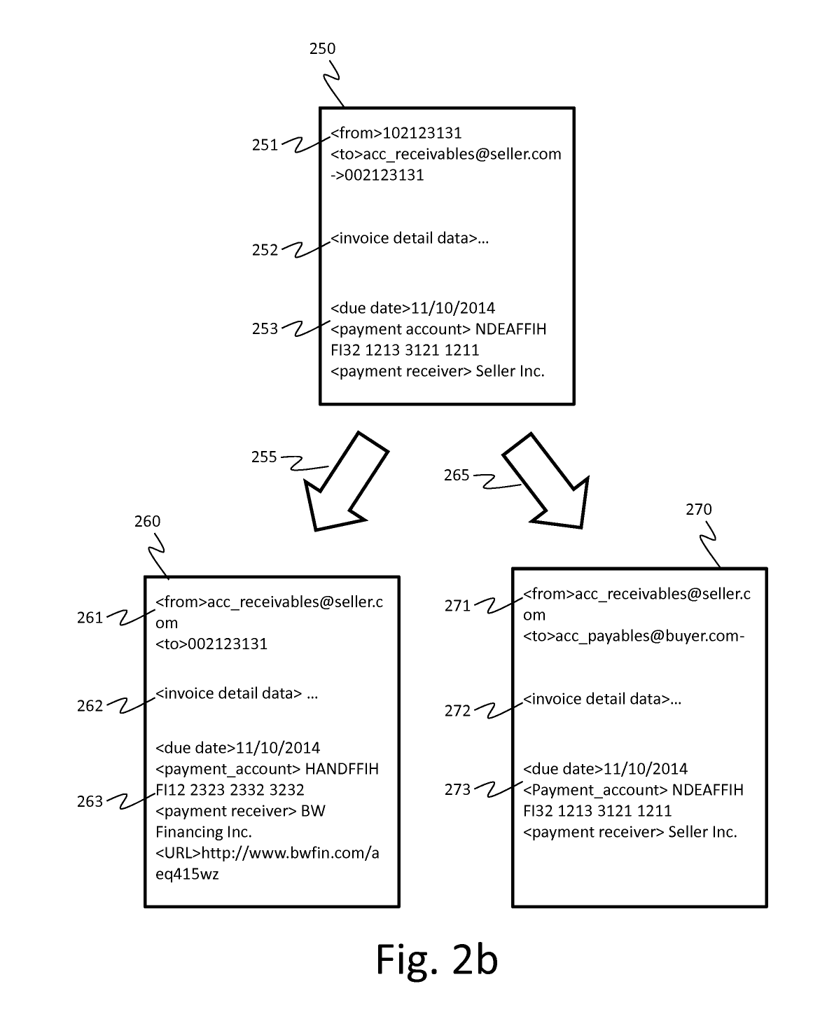

FIG. 1b depicts an arrangement of computer systems and the flow of data between the systems according to a preferred embodiment of the present invention. The sender system 130 is adapted to create transactions to be transmitted in the network (120 in FIG. 2a). In an embodiment, the sender system may comprise an invoicing software adapted to create invoices to be sent to the network. The system may be implemented as a software-as-a-service SaaS solution. The sender system sends 142 the transaction, e.g. invoice, to the sending router 131 which comprises functionality to forward 144 the received transaction in a transaction transmission network to another router 132. In an embodiment, the sender system and sending router may be combined into a single system. In an embodiment, the sending router 131 is operated by the operator of a first transaction transmission network and the sending & receiving router 132 is operated by the operator of a second transaction transmission network. There may be an arrangement between the two networks to route transactions to each other e.g. in the case where the recipient address of the transaction does not reside in the sender's network.

When the sending and receiving router 132 receives the transaction, it detects from the recipient address information that the transaction must be routed 145 to the service router 133 which in an embodiment is adapted to alter or amend e.g. the recipient address and/or possibly some other content information of the received transaction to make the transaction suitable for forwarding it 147, 148 to the various value-add services 134, 135 and to the receiver system 137 of the invoice. In an embodiment, the service router changes the recipient address of the transaction to one that is known by the receiving router 136. The service router may also add e.g. a URL to the transaction, e.g. invoice data that is usable by the user of the receiver 137 to access at least one transaction-related service via the service router 133. The value-add services 134, 135 may comprise e.g. financing services offered to the sender 130 or receiver 137 of the invoice. Once the service router 133 has modified the content of the transaction, it forwards 146 it back to the sending and receiving router 132 of the transaction transmission network. The router 132 forwards 150 the transaction to the receiving router that is known or at least assumed to be able to further route 152 the transaction to the receiver 137, e.g. the invoice processing system of the buyer of an invoice.

In an embodiment, the sending router 131 may check 155 for each transaction, e.g. by sending the transaction data to a service interface (175 in FIG. 1c) accessible e.g. using an URL, if the transaction can be routed by the service router 133. This address verification check may occur at the service router 133 before the router 131 attempts to route the transaction using its regular routing logic, e.g. before sending the transaction further in its own network or to the sending and receiving router 132. If the service router 133 identifies, e.g. from the address information of the transaction, that the sender of the transaction already has subscribed at least the routing service at the service router, the service router accepts the transaction for routing. Otherwise the service router 133 rejects the transaction and the sending router 131 continues with the routing of the transaction.

In a preferred embodiment, the receiver system 137 acknowledges 151 the receipt of the transaction to the receiving router 136 which forwards 149 the acknowledgement to the router 132 which forwards 145 it to the service router 133. Now the service router may send 146 an acknowledgement to the router 132 that forwards 143 it further to the sending router 131 which reports 141 the successful sending of the transaction to the sender system 130. Alternatively or additionally, the service router 133 may also update its own address directory with the information obtainable from the receipt acknowledgement. In an embodiment, the service router creates a new account for the receiver, a new entry in its service directory and creates a delivery address for the receiver 137 that is later usable by the receiver.

In a preferred embodiment, the service router is adapted to be able to handle other transactions (e.g. state change notifications) related to the original transactions. For example, when receiver system 137 has approved the invoice, it may send 151 an approval message to the receiving router 136 which further forwards 149 it to the router 132 which delivers 145 it to the service router 133. The service router comprises logic that matches the approval message with the original transaction. Now the service router is able to notify those services 134, 135 which may need the approval information. The service router may also forward the approval message to the sender 130, should it be deemed necessary. For example, if the service 134 is a dynamic discounting service that finances approved invoices by buying them at a discounted price once the invoice has been approved, then only the dynamic discounting service may need to know about the approval of the invoice. To implement this routing logic of transactions related to the original transaction, the service router may maintain information about the current state of each active service of the original transaction. The service router may thus comprise computer executable code to implement a service to set the current status (or state) of a service regarding a transaction. The service may be made available to the value-add services 134,135 of an embodiment of the invention using a suitable application programing interface (API).

FIG. 1c depicts some details about an exemplary implementation of the service router 133.

The service router 133 is adapted to exchange transactions, e.g. invoices, and other information related to the transactions, e.g. state change information, e.g. approval information, with the sending and receiving router 132 via a message exchange interface 166, which may be implemented e.g. as an API (application programming interface). The sending and receiving router 132 is adapted to receive transactions from transaction sources 160 via their message exchange interfaces 161 and send transactions to the transaction destinations 163 via the message exchange interface 164. The service router 133 further comprises a data access and/or exchange interface 172, e.g. an API, for the purpose of enabling implementation of the value-add services 173 that are based on the transactions handled by the router 133.

In an embodiment, the transaction source may send 162 the transaction also directly to the service router via communication interface 175 adapted to receive transactions from data sources.

In the service router 133, which in a preferred embodiment comprises a collection of software-based services implemented using some suitable software development tools and techniques well known to a person in the art, the address manager 167 translates an address (“virtual endpoint”) provided and/or recognized by the service router into a physical delivery address (endpoint) recognized by the router of the source or destination network. The address manager resolves the physical delivery address from the data content of the received transaction or it may resolve the address from the directory of the routing management system. The directory resides in the data storage 171 of the service router. The data storage further contains the transactions that the service router has received and/or sent. The storage may further contain status information about at least some services related to the transactions routed by the service router.

The document manager 168 analyzes the content of the received document and alters the content of the document, e.g. the address information, to make the document suitable for forwarding to the end recipient 163 (137 in FIG. 1b) and to at least one value-add service, e.g. a financing service. The document manager may also add an “invitation URL” to the transaction, e.g. an invoice, to enable the user of the transaction destination 163 to access 165 a transaction- or customer-specific service accessible via the service router.

The service manager 169 resolves services, e.g. value-add services 173, that are relevant, e.g. that have been subscribed for the incoming transaction and makes (the suitable part of) the transaction data available to the value-add service 173 via the interface 172. The service manager may also maintain the process state of each of the ongoing services of the transaction. For example, the service manager may keep track of the approval status of an invoice. The state information may be used to determine, which processes (implemented by the services 173) should receive e.g. a transaction-related message received by the service router.

The common services 170 comprise e.g. services that the recipient may access through the invitation URL of the invoice. These may include for example maintaining directory data of the organization (sender or receiver), managing users of the organization, reporting manually the status change of the invoice (e.g. inform about approval of the invoice) and collaborating with the value-add service provider and/or the sender or receiver of the transaction in the context of the transaction and/or the value-add service.

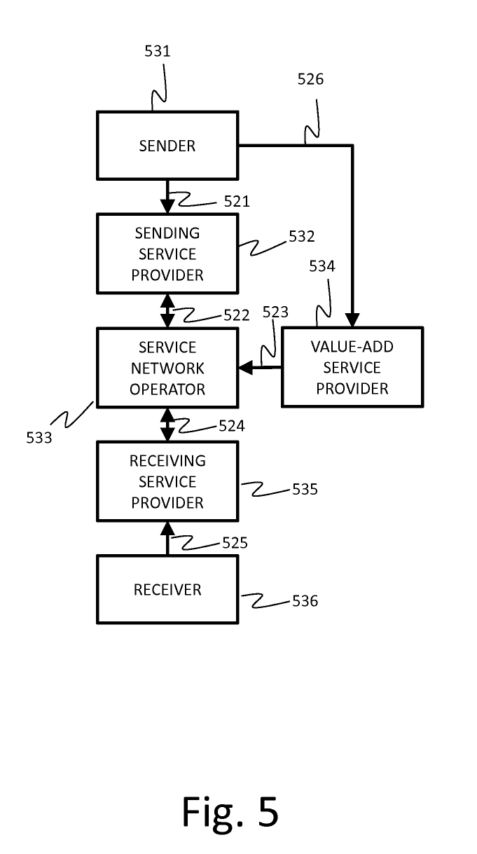

The revenue manager 174 provides services for implementing a revenue sharing functionality that utilizes the service routing method of an embodiment of the present invention. An exemplary method for revenue sharing in the system of FIG. 1c is described in detail in FIG. 5.

FIG. 2a shows some data tables that, by way of a simplified example, provide guidance to implementation of the data model of the service router of an embodiment of the present invention. The routing information table 200 comprises columns for ID, virtual endpoint (i.e. address of a customer or service provider at the service router), physical endpoint (i.e.

address in the network of the customer), operator ID (operator of the customer's network), organization ID (customer entity's unique ID) and a contact address (e.g. an e-mail address to contact a person in the customer organization). The table contains in the shown example four rows. The row 201a has the address data of a buyer organization. The row 201b has the address data of a seller organization. The row 201c has the address data of the factoring service provided by a financing company. The row 201d has the address data of a buyer financing service provided by the same financing company.

Table 210 shows some exemplary data of a service directory table. The table comprises the unique identifier for each service, the name of the service and the identifier of the endpoint (address at the service router) at which the service is accessible. The identifier refers to the ID of the row of the routing table. The row 211a contains the data of a factoring service, the row 211b contains the data of a buyer financing service and the row 211c contains the data of the routing service that is a system service that needs to be subscribed to by all customers of the service router who wish to subscribe to any of the value-add services, such as factoring or buyer financing.

The table 220 contains the data of the active service subscriptions of the customers (senders and/or receivers of transactions) of the routing server. The table contains columns for a unique subscription ID, the organization ID of the subscribing customer, the ID of the subscribed service and the customer's endpoint (ID of the row of the routing table) to be used in the context of the subscribed service. The row 221a comprises the subscription data of the buyer financing service subscribed by the buyer organization. The row 221b comprises the subscription data of the factoring service subscribed by the seller organization. The rows 221c and 221d comprise the subscription data of the routing service for the seller and the buyer.

The service state table 230 contains data of the current status (state) of ongoing services for each transaction that falls into the scope of the service subscription. For example, the state of a factoring service for a transaction that the seller has decided to be financed, is stored in this table. The table contains columns for unique subscription ID (refers to the ID of table 230), ID of the transaction being used by the service, virtual end points of the sender and receiver of the transaction and the current state (status) of the service. The row 231a has the current state of the buyer financing service subscribed by the buyer, the row 231b has the state of the factoring service subscribed by the seller and the row 231c has the state of the routing service subscribed by the seller. In an embodiment, the state data that indicates that the service is still expecting to receive data from the network, instructs the service router to forward received data to the service if the received data is of type that is relevant to the service. For example, for the exemplary buyer financing service, the payment notification from the buyer is relevant information but any communication between the seller and the factoring service may not be relevant. The service router may thus filter, e.g. based on the type of the received data and the state of the ongoing services, which services are entitled to have access to which data related to the transaction.

FIG. 2b shows the alteration and amendment of some content data of an exemplary invoice transaction according to a preferred embodiment of the present invention. The incoming transaction has address information 251 that contains a sender address and a recipient address. In the shown example, the sender address “102123131” is the endpoint address of the sender known to the operator of the transaction transmission network whose customer the sender is. The recipient address “acc_receivables@seller.com->002123131” comprises the virtual address “acc_receivables@seller.com” of the sender (i.e. transaction delivery address of the sender at the service router) amended with the physical delivery address “002123131” of the recipient. This virtual endpoint is the address that has been activated for the purpose of enabling at least one application and/or routing service for the transaction. With this address information, the sender operator's router 131 and the router 132 are able to route the transaction to the service router 133. If the transaction source, e.g. the sending router 131, is able to send the transaction directly (155 in FIGS. 1b, 162 and 175 in FIG. 1c) to the service router 133, the recipient address does not necessarily need the virtual endpoint address of the sender. Instead, the physical delivery address (“002123131” in the shown example) of the recipient may be used. In such case, the address of the interface 175 (FIG. 1c) (e.g. a URL) to which the transaction was directly sent is the address activated for the purpose of enabling at least one application and/or routing service for the transaction.

In an embodiment, the recipient address of the invoice 250 may also be or comprise the virtual endpoint address of the buyer (e.g. acc_payables@buyer.com), if such address already exists at the service router and is known by the sender of the invoice.

The invoice detail data 252 comprises the invoice line items and the invoice total amount, for example. The payment instruction data 253 of the shown example comprises the due date and payment account information. The payment account number is the bank account of the seller.

In a preferred embodiment, the content of the received transaction data is altered and/or amended to be better suitable for at least one service available via the service router 133. The services include, in addition to at least one value-add application service, e.g. financing, the routing service provided by the router as a system service. In the shown example, two versions of the transaction are created e.g. by the document manager 168 of the service router. The word “document” may be in this context understood as a “transaction”. As the result of the conversion process 255, a version suitable for the end recipient of the invoice is created. The address information 261 of the invoice is modified by changing the sender address to the virtual address (i.e. transaction delivery address of the customer at the service router) of the sender. To make it possible for the recipient's operator to route the invoice to the recipient, the recipient address of the invoice is changed to the physical e-invoicing address of the buyer. The invoice detail data 262 of the shown example is left unchanged. In addition to the alteration of address information 261, the payment instructions 263 are changed in the shown embodiment. The payment account number is changed to the bank account of the financing service. Finally, a URL to the transaction-specific services available e.g. at the service router for the receipient is amended to the transaction 260. The services available via the URL may be provisioned e.g. by the service manager (169 in FIG. 1c). Some of the services may be common services (170 in FIG. 1c) and some of them may be value-add services (173 in FIG. 1c) provided by value-add service providers, e.g. financing companies.

As the result of the conversion process 265, a second version 270 of the transaction 250 suitable for a value-add service provider, e.g. financing service provider, e.g. factoring company, is created. In the shown example, the sender and recipient addresses are changed into virtual endpoint addresses maintained by the service router 133 (FIG. 1c) and stored in the storage 171 (FIG. 1c). The detail data 272 and payment instruction data 273 are left unchanged.

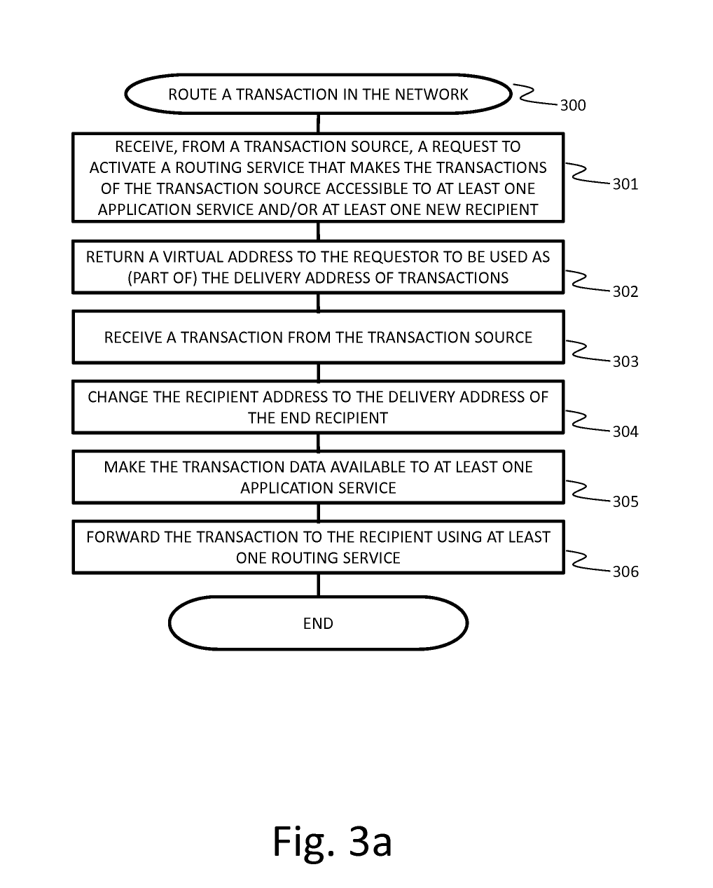

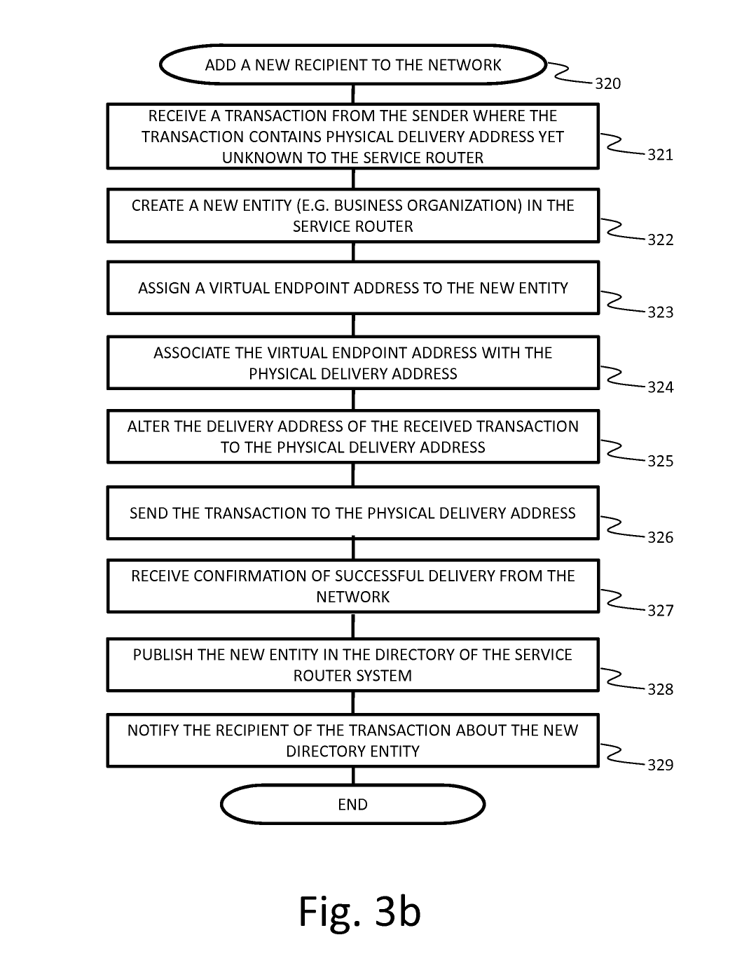

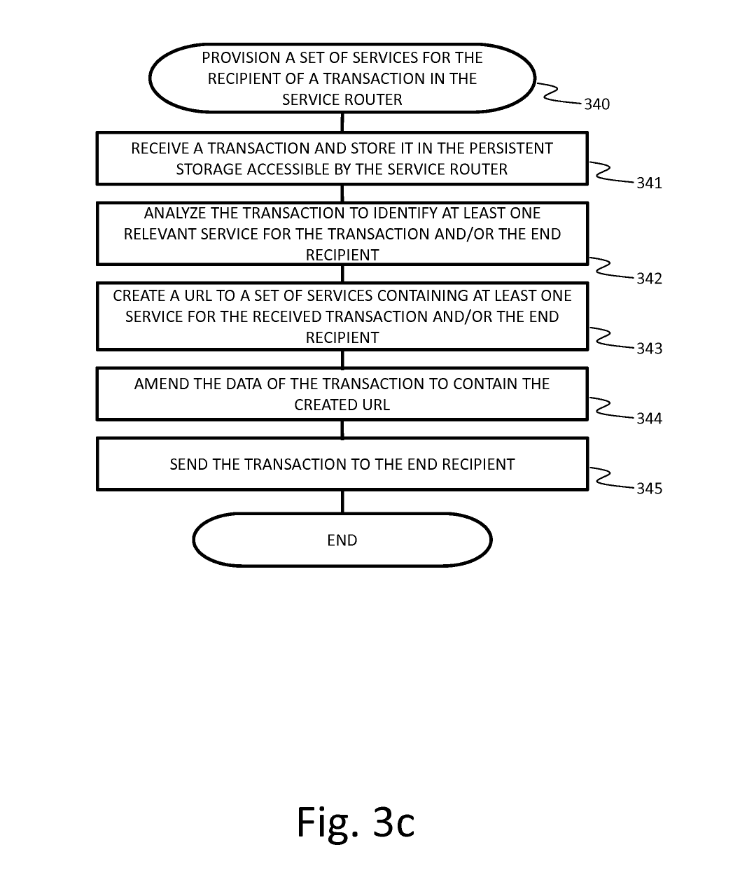

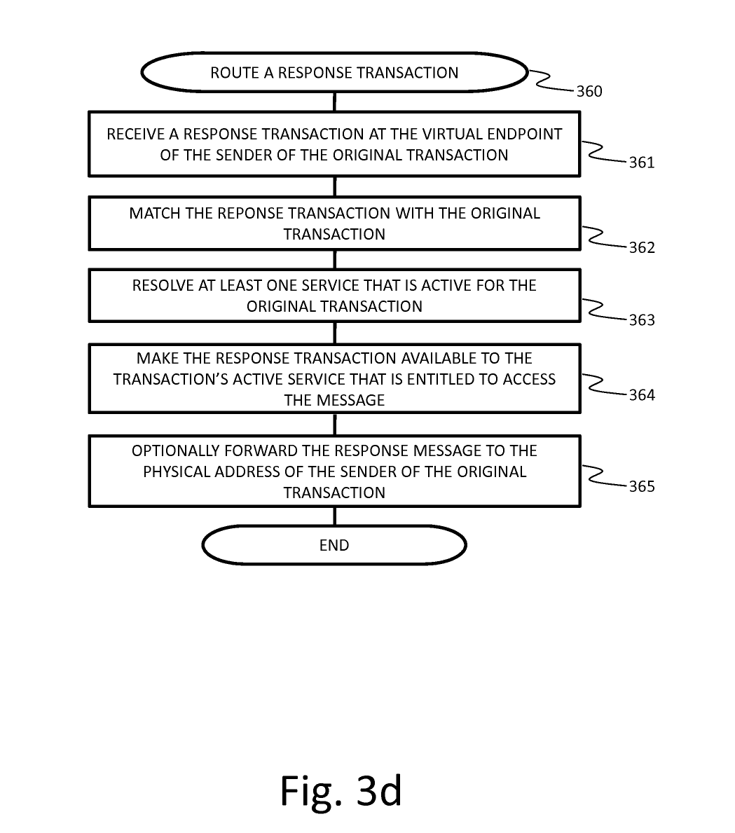

FIG. 3a depicts, by means of a flow chart, the steps of routing a transaction in the network comprising the service router 133 (FIGS. 1b, 1c) of a preferred embodiment of the present invention. In step 301, the service router 133 receives from a transaction source, e.g. sender 130 or sending router 131a request to activate the routing service of the service router. The routing service makes the transactions of the transaction source deliverable to at least one application service 173 and/or at least one recipient. The recipient may be one that is unavailable to the sender without the routing service. In an embodiment, the routing service of the service router 133 is adapted to act as an intermediary routing service between two networks operated by different operators where the networks are unable to exchange transactions with each other and/or the networks are themselves unable to provide access to the application service 173. In response to the request of step 301, the service router 133 returns 302 a virtual (endpoint) address to the requestor to be used as part of the delivery (recipient) address of the transactions received from the transaction source. An example about the recipient address comprising the virtual endpoint address of the sender and the physical address of the recipient is provided in the data element 251 of the FIG. 2b. In an embodiment, the recipient address field contains only the virtual endpoint address of the sender and the actual physical endpoint address is stored in some other field of the received transaction. The steps 301 and 302 are needed only, if the sender does not yet have a virtual address defined at the service router 133. In step 303, the service router receives a transaction from the transaction source, which may be e.g. the sender 130 that sends the transaction to the sending router 131 for routing the transaction to its destination. In step 304, the service router changes, e.g. using the address manager 167 and document manager 168, the delivery address of the transaction to the physical endpoint address of the end recipient (137 in FIG. 1b). This step is optional. It may not be needed, if the source of the transaction, e.g. router 131 (FIG. 1b) had sent the transaction directly (155 in FIG. 1b) to the service router 133 (FIG. 1b) and the service router has accepted the transaction for routing e.g. because the sender 130 of the transaction has an active service subscription in the service router. The service router may also change the sender's address e.g. from the physical endpoint address of the sender to the virtual endpoint address as shown in 251 and 261 of FIG. 2b. In step 305, the transaction data is made available to at least one service, e.g. by granting access to the data in storage 171 or by sending the data to the at least one service. The service may be a common service 170 (in FIG. 1c) or a value-add service 173 (in FIG. 1c) provided by a value-add service provider. The service manager may utilize the service subscription data shown in FIG. 2a for the determination of services that are applicable to the received transaction. Finally, in step 306, the altered transaction is forwarded to the end recipient using at least one routing service that is able to route the transaction to its destination using the physical recipient endpoint address of the transaction.

FIG. 3b shows the method 320 of adding a new recipient (137 in FIG. 1b) to the network known to the service router (133 in FIGS. 1b, 1c). In step 321, the service router 133 receives a transaction from the sender that is already known to the router 133. The transaction contains the physical delivery address of an end recipient that resides in a network that is known to the service router. However, the service router has not yet created a directory entry about the new recipient in its own routing directory. In step 322, the service router creates a new entry about an entity, e.g. a business organization, into the routing directory (e.g. 200 in FIG. 2a). The information of the new entry is mostly extracted from the received transaction, e.g. an electronic invoice, which typically contains name and address information, physical endpoint address of the recipient as well as some contact information about the recipient of the transaction. In addition to the information obtainable from the received transaction, the service router creates 323 a new a virtual endpoint address for the recipient and assigns 324 the new address with the created directory entry which contains the physical endpoint address of the recipient. The virtual endpoint address is now usable as the address of the entity in the service router. Next, in step 325, the delivery address of the received transaction is altered to be the physical delivery address of the recipient. The transaction may also be amended by adding a URL to the transaction that allows the recipient to access e.g. the transaction data, a service related to the transaction and/or the new directory data of the recipient at the service router. The altered and/or amended transaction is then sent 326 to the physical delivery address by forwarding it e.g. to the router 132 of FIG. 1b which forwards it to the receiving router 136 which sends the transaction to the physical endpoint address of the receiver system 137. Once the transaction has been successfully delivered, the service router 133 receives a delivery confirmation from the router 136 via the router 132. Now the new directory entry of the service router's routing directory is known to be a valid one and it may be published in the directory 328. In step 329, the recipient of the transaction may be notified about the published directory entry e.g. by sending an e-mail to the contact address mentioned in the directory entry.

A transaction that has been sent to the service router may be associated with a set of services that are anticipated to be relevant to the recipient of the received transaction. The FIG. 3c illustrates the method 340 of provisioning a set of services for the recipient of a transaction in the service router. In step 341, the service router 133 (FIGS. 1b, 1c) receives a transaction and stores it in the persistent storage accessible by the service router. Next in step 342, the service router analyzes, e.g. by the service manager module 169, the content of the transaction and identifies at least one service for the transaction and/or the end recipient and associates the set of services with the transaction and/or recipient. In step 343, the service router creates 343 a URL that is associable with the set of services and amends 344 the data of the transaction to contain the created URL. Finally in step 345, the service router sends the transaction to the end recipient.

FIG. 3d shows a flow chart about the method 360 of routing a response transaction from the recipient of the transaction. When the recipient of the original transaction has received the transaction, it may either immediately or after some time return a response transaction to the network. Such transaction needs to be routed to those parties, to whose the response is a relevant one. Those parties may comprise e.g. the sender of the original transaction and/or at least on service provider of a value-add service. In step 361, the service router receives a response transaction (e.g. payment approval notification) that has been addressed to the virtual endpoint of the sender of the original transaction (e.g. an invoice). The service router matches 362 the response transaction with the original transaction and resolves 363 at least one service that is active for the original transaction.

The service router may use the data of the service state table 230 in the resolution task. Next, the service router makes 364 the response transaction available to the resolved service(s). If the response message needs also to be forwarded to the sender 130 (FIG. 1b) of the original transaction, the service router forwards 365 the transaction to the physical address of the sender.

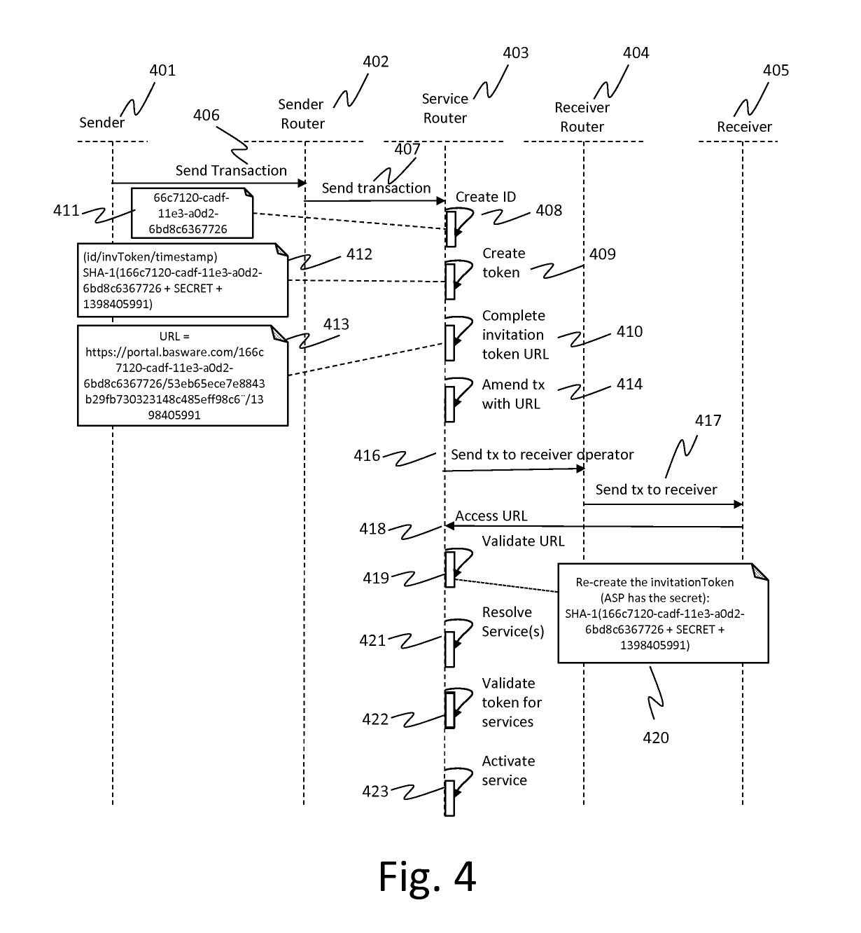

FIG. 4 depicts an event diagram that illustrates an example about the creation of a service invitation URL to be used in some preferred embodiments of the present invention. The participants of the arrangement typically comprise a transaction sender 401, e.g. the invoicing system of a seller organization (130 in FIG. 1b). The transaction sender is communicatively connected to a sender router 402 (131 in FIG. 1b), which is further communicatively connected e.g. via the sending & receiving router (132 in FIG. 1b) to the service router 403 (133 in FIG. 1b). The service router is communicatively connected to the receiving router (136 in FIG. 1b) e.g. via sending & receiving router 132. The receiver router is arranged to transmit transactions, e.g. electronic invoices and/or purchase orders, to the transaction receiver 405, e.g. the invoice approval system or the order management system of a business organization.

In step 406 of the event diagram, the transaction sender system 401 sends a transaction to the sender operator 402. In an embodiment, the sender 401 and the sender router 402 may reside in the same computer system. The transaction origin system, e.g. an invoicing system, may thus comprise also the functionality of the sender router or the sender router system may comprise an invoicing system.

In the shown embodiment, when the sender router 402 receives the transaction, it forwards the transaction to the service router 403 which creates a service invitation URL (“invitation token”) to be amended to the transaction.

In the embodiment shown herein, the creation of the token comprises three steps that are executed in the system 402. First, a unique ID (within the domain of the service router 403) is created 408 for the transaction, if such ID does not exist yet. In a preferred embodiment, the ID is able to identify also the transaction origin system 201. The ID may comprise components. In the example ID shown in 411, the beginning of the ID string “66c7120” may identify the origin system, the string “cadf” may identify the type of the transaction and the rest of the string identifies the transaction uniquely within the transaction origin system. Next, a hash value belonging to the token is created 409 by concatenating at least part of the document id, the shared secret known both to the system 402 and to the service router 403 and a timestamp and calculating a hash value of the concatenated string using a suitable hash algorithm. The use of the shared secret is optional and needed only, if the URL is created upon the request of the transaction source, typically the sender router 402. An example of the token is shown in box 412. To complete the creation of the token, a URL is created 410 in the system 402 by concatenating a domain name (in the example shown in 413 the domain is “https://portal.basware.com/”), (the part of) the document ID that is used in the hash, the calculated hash value and a timestamp which represents the creation time of the token. Next, the service router 403 amends 414 the transaction data (e.g. XML data) with the created URL. In many standard transaction formats there is a URL field available for a URL relevant to the transaction.

In step 416, the service router sends the amended transaction to the receiver router 404 which further forwards 417 it to the transaction recipient 405, e.g. buyer. The recipient's system is adapted to display the Invitation Token URL 413 in the user interface of at least one of its applications or application services. The user of the application (service) of the transaction recipient 405 may now click 418 the URL, which takes the user to an application service provided by the service router 403. At the service router, the URL is first validated 419 by reconstructing the token from its components (e.g. the id, the secret indicating the trust relationship between the service router and the requestor of the URL and the timestamp) and the hash value of the reconstructed token is compared with the hash value of the received token. An example about the re-construction of the token is shown in box 420. If the URL is valid, the services that have been activated for the receiver 405 of the transaction e.g. by the service router 403, sender operator 402 or sender 401 are resolved 421. Note that the receiver organization identity is resolvable from the unique ID of the transaction. Once the services have been identified, the validity of the services for the recipient and the transaction may be further validated 422 using the information of the token, e.g. the timestamp. For example, a service may be available for the transaction for only a limited period of time. Finally, the services that are deemed valid for the recipient and the transaction are activated 423.

It is noteworthy that the transaction to be transmitted from the system 401 to system 405 may be amended with the invitation token of an embodiment of the present invention by any participant of the transaction transmission network that is adapted to send and/or receive the transaction in the transaction transmission network. It is thus possible, that the transaction is amended with the invitation token e.g. by system 401, 404 and/or 405. In a preferred embodiment, the URL is automatically amended to the transactions managed by the service router 403 without any request from another system. If the requestor of the URL is some other system than the service router 403, the amending system must have established a trust relationship with the service router 403 e.g. by establishing a shared secret with the system 403 or by establishing a user account at the system 403.

It is also noteworthy, that the transaction may comprise multiple invitation tokens, e.g. one for the service router 403 and one for each system that has established a trust relationship with the service router 403. The tokens may be concatenated into the same URL or they may be amended to the transaction as separate URLs.

In a preferred embodiment of the present invention, the value of the transaction managed, modified and/or transmitted by the service router of an embodiment of the invention increases as some value-add services 134, 135, e.g. supplier and/or buyer financing, are provided on the transaction. FIG. 5 shows an example about how the added value and revenue generated from that added value may be distributed among the participants of the process. In the shown example, the sender organization 531 has subscribed to a value-add service (VAS), e.g. a financing service, provided by a VAS provider 534. When the VAS provider has completed the service on the transaction, e.g. an invoice, it charges a service fee 526 from the subscriber 531 of the service. In the shown embodiment, the value-add service provider 534 needs to share some of the earned revenue with the organizations operating systems 532, 533, 535 because those organizations contribute to the availability of the data that made the service of the VAS provider 524 possible. The VAS provider thus sends a share, e.g. a percentage, of the earned revenue 523 to the revenue management service 174 (FIG. 1c) of the service network operator 533. In an embodiment, the service network operator operates the sending and receiving router 132 and the service router 133 of FIGS. 1b and 1c. The revenue management service may have a financial account for any or all of the participants 130, 131, 134, 135, 136, 137 of the arrangement of FIG. 1b for crediting and debiting service fees to/from the participant.

Each account holder may have its own virtual endpoint address in the service router 133. Upon receipt of the payment to one of the accounts, the revenue management service resolves, e.g. from the routing data of the related transaction(s), the participants of the process, e.g. 532, 535 who contributed to the data of the service and credits the accounts of those participants with a share, e.g. a percentage, of the payment it received from the source of the revenue, e.g. the VAS provider 534. In an embodiment, the routing information of the transactions and/or state change events is used to determine the recipients of the fees.

Instead of or in addition to the execution of value-add services, value-add events, e.g. events where a fee is charged upon processing of at least one transaction, may occur also elsewhere. In the shown embodiment, the sender of a transaction is charged 521 by the sending service provider 532 a fee for sending a transaction into the service network 533. Similarly, the receiver 536 of the transaction may be charged a fee 525 by the receiving service provider 535 about receiving the transaction from the network. In a preferred embodiment, the service network operator 533 charges a share, e.g. a percentage of those fees and credits at least one participant of the related process with a share of the charged fee. For example, the sender operator of a successfully delivered transaction may be credited with a percentage of the fee that the receiver operator charges from the recipient organization of the invoice document (transaction).

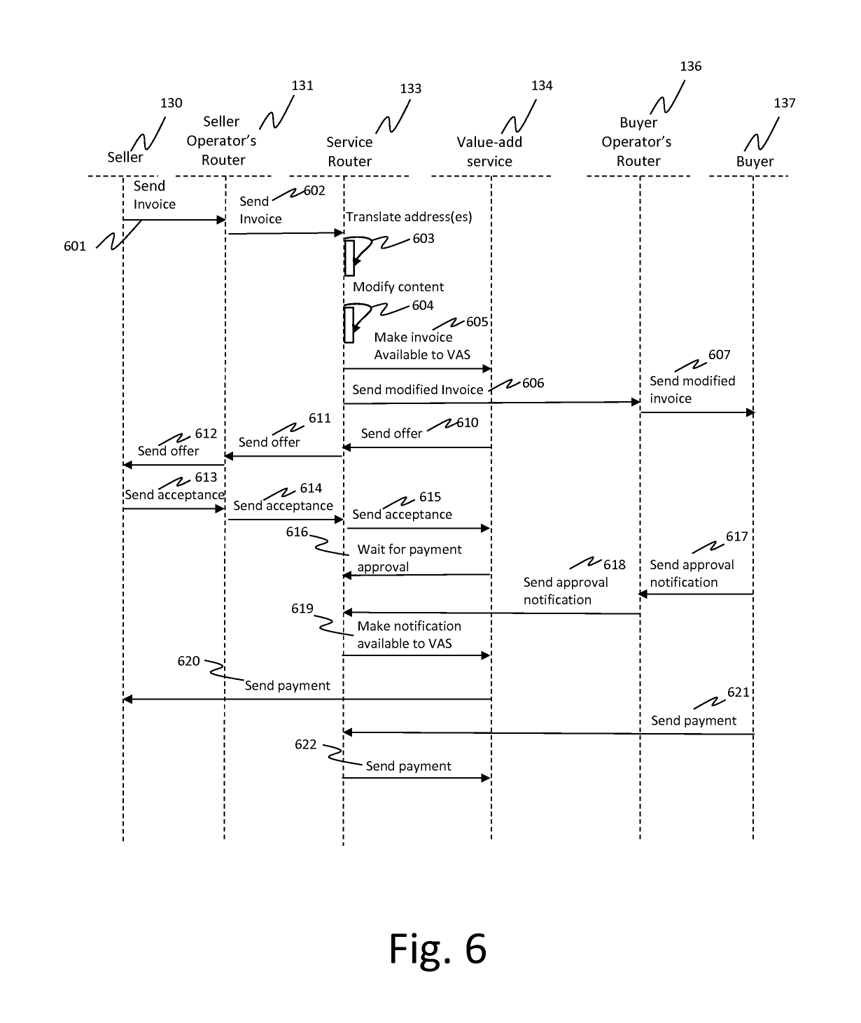

The inventors speculate, that a preferred embodiment of the present invention may be particularly advantageous for implementing value-add services such as financing services in the electronic transaction transmission network transmitting invoices. The event diagram of FIG. 6 shows an example of implementing a dynamic discounting service utilizing the address and content modification capabilities as well as routing capabilities of the service router.

The seller system 130 sends 601 an invoice to the seller operator's router 131. The content of the invoice may be e.g. one shown as 250 in FIG. 2b. The seller operator's router routes the invoice to the service router 133. Between the routers 131 and 133 there may be additional routers, e.g. the sending and receiving router 132 of FIG. 1b. When the service router receives the invoice, it may translate e.g. at least the recipient's address from one comprising a virtual endpoint address (sender's or recipient's address at the service router) to one that is suitable for delivering the transaction to the buyer 137. In the shown example, the service router also modifies 604 the content of the invoice. The modified invoice may be e.g. one shown as invoice 260 in FIG. 2b. The modifications comprise new payment instructions. Instead of paying the invoice to the account of the seller, the buyer is instructed to pay the invoice to the account of the service router operator or some other party handling payments of at least one financing service. The service router makes also another version of the invoice, e.g. one shown as invoice 270 in FIG. 2b, that may then be made available 605 to the provider of a value-add service 134. The data may be made available e.g. by granting the value-add service access rights to the data or sending the data to an address associable with the value-add service. The invoice 260 is then sent 606 from the service router to the buyer operator's router 136 which forwards the invoice 607 to the buyer 137. Now the invoice has been delivered to the buyer.

The value-add service (VAS) 134 may, at any point of time after receiving the invoice, send a financing offer to the seller e.g. for a proposal for quick payment of an approved invoice at a discounted price. The VAS 134 sends 610 the offer transaction, which is a second transaction that's related to the original transaction sent 601 by the seller, to the service router which sends it further 611 to the seller operator's router 131 which forwards it further 612 to the seller. The seller may now accept the offer and send the acceptance transaction (message) 613 to the seller operator's router 131 which forwards 614 it further to the service router 133 which makes it available 615 to the value-add service 134. Now the value-add service may instruct the service router to wait 616 for payment approval messages and, if such message is received for the transaction sent to the buyer, make it available to the value-add service 134.

When the buyer approves the invoice, the invoice processing system of the buyer sends approval notification 617 to the buyer operator's router 136 which forwards 618 the approval notification to the service router 133 that makes 619 the notification available to the VAS. In another embodiment, the approval notification may be entered by the buyer also utilizing a service available at the service router. The service may be activated using the URL that was amended to the invoice 260 sent to the buyer. An example about constructing the URL is shown FIG. 4. Other construction methods or URLs known to a person skilled in the art may also be utilized. Once the VAS has received the approval notification, the VAS may send payment 620 to the account of the seller 130 according to the offer sent at step 610. Later, the buyer sends 621 the payment to the bank account of the operator of the service router 133 which forwards 622 the payment to the provider of the (dynamic discounting) service provider 134.

The embodiment shown in FIG. 6 or any other embodiment of the present invention may be accompanied with a profit sharing method shown in FIG. 5. The method of an embodiment (not shown in FIG. 6) may thus comprise e.g. the service router 133 observing an occurrence of a value-add event. The value-add event may be created e.g.

when the value-add service 134 (534 in FIG. 5) reports a charged fee to the service router e.g. upon completion of the service. The service router may now debit a part of the charged fee from the account of the value-add service provider, credit a part of the debited fee e.g. to the account of the seller's operator 532 and credit another part of the fee to the account of the buyer's operator 535. The debiting and crediting may be performed e.g. by the revenue manager 174 of the service router 133 (FIG. 1c).

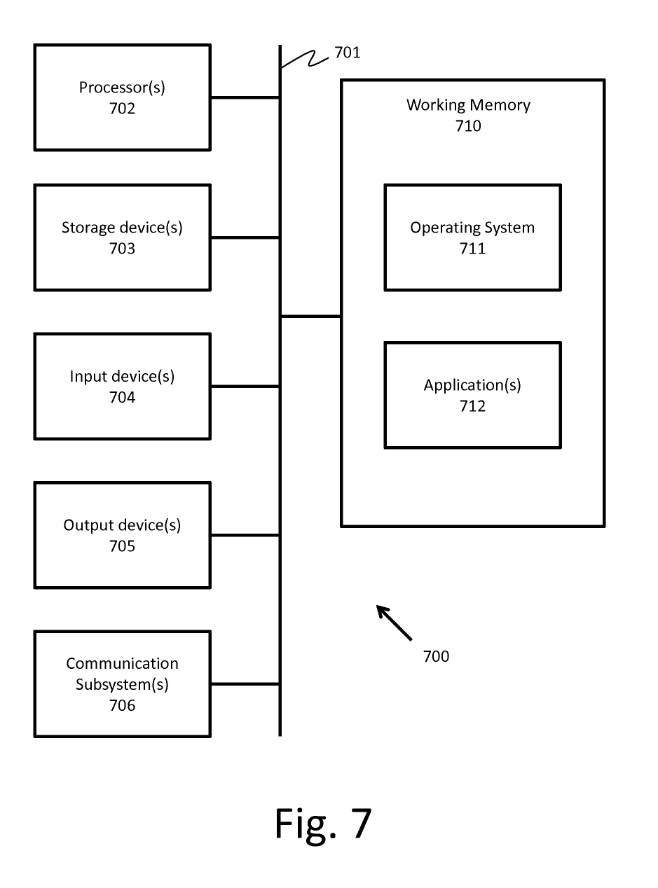

FIG. 7 shows a schematic illustration of one embodiment of a computer system that can perform the methods of the described embodiments of this disclosure. It should be noted that the FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 701 (or may otherwise be in communication, as appropriate). The hardware elements can include one or more processors 702, communication subsystems 703, one or more input devices 704, which can include without limitation a mouse, a keyboard and/or the like; and one or more output devices 705, which can include without limitation a display device, a printer and/or the like. The computer system 700 may further include (and/or be in communication with) one or more storage devices 703. The computer system 700 also can comprise software elements, shown as being located within the working memory 710, including an operating system 711 and/or other code, such as one or more application programs 712, which may comprise computer programs of the described embodiments, and/or may be designed to implement methods of the described embodiments of a computer-method of the embodiments as described herein.

At least some embodiments may include a program storage device readable by a machine, tangibly embodying a program of instructions executable by the machine to perform a computer-method of an embodiment of the present invention.

Although specific embodiments have been described and illustrated, the embodiments are not to be limited to the specific forms or arrangements of parts so described and illustrated.

1. A computer executable method for routing a transaction in a transaction transmission network comprising at least one sender, at least one recipient, at least one application service and a service router, wherein the method comprises steps executable by a computer for:
a. receiving a transaction from the network at an address activated for the purpose of enabling at least one application and/or routing service for the transaction wherein the address comprises an identifier associable with the sender,
b. executing, by the service router and while the transaction is being routed to the recipient, an address translation or verification function to enable transmission of the transaction to the recipient,
c. associating the transaction with at least one application service for the purpose of managing availability of the received transaction and/or further data associable with the received transaction to the application service, and
d. forwarding the transaction to the recipient in the network.

2. A method according to claim 1, wherein the network also comprises at least one second router adapted to send and/or receive transactions to/from the service router.

3. A method according to claim 2, wherein the step of forwarding the transaction to the recipient comprises forwarding the transaction to the second router adapted to route the transaction to the recipient directly or via at least one other second router.

4. A method according to claim 1, wherein the address translation function alters the recipient address of the transaction while it is being processed at the service router.

5. A method according to claim 1, wherein the address translation function performs a translation between an address comprising a virtual endpoint address and an address comprising a physical endpoint address.

6. A method according to claim 1, wherein the method further comprises the step of amending or altering the transaction's content data.

7. A method according to claim 7claim 6, wherein the amendment comprises at least one URL associable with at least one service applicable to the transaction and/or the recipient of the transaction.

8. A method according to claim 2, wherein the method comprises the step of debiting or crediting the financial account of at least one of the sender, the receiver, at least one router, and the application service provider based on the routing data of the transaction and after completion of a chargeable service related to the transaction.

9. An arrangement for routing a transaction in a transaction transmission network comprising at least one sender 0), at least one recipient, at least one application service and a service router, wherein the arrangement comprises computer means for:
a. receiving a transaction from the network at an address activated for the purpose of enabling at least one application and/or routing service for the transaction wherein the address comprises an identifier associable with the sender,
b. executing, by the service router and while the transaction is being routed to the recipient, an address translation or verification function to enable transmission of the transaction to the recipient,
c. associating the transaction with at least one application service for the purpose of managing availability of the received transaction and/or further data associable with the received transaction to the application service, and
d. forwarding the transaction to the recipient in the network.

10. A tangible computer storage medium comprising computer executable program code for an routing a transaction in a transaction transmission network comprising at least one sender, at least one recipient, at least one application service and a service router, wherein it comprises computer executable instructions for:
a. receiving a transaction from the network at an address activated for the purpose of enabling at least one application and/or routing service for the transaction wherein the address comprises an identifier associable with the sender,
b. executing, while the transaction is being routed to the recipient, an address translation or verification function to enable transmission of the transaction to the recipient,
c. associating the transaction with at least one application service for the purpose of managing availability of the received transaction and/or further data associable with the received transaction to the application service, and
d. forwarding the transaction to the recipient in the network.
